(19) United States
(12) Patent Application Publication
(10) Pub. No.: US 2010/0284269 A1
(43) Pub. Date: Nov. 11, 2010

(54) Multi-Node State Recovery for a Communication Network

(76) Inventor: Shan Zhu, Plano, TX (US)

Correspondence Address: BAKER BOTTS L.L.P., 2001 ROSS AVENUE, SUITE 600, DALLAS, TX, 75201-2980, US

(21) Appl. No.: 12/437,328

(22) Filed: May 7, 2009

(51) Int. Cl. G06F 11/00

(52) U.S. Cl. 370/221

(57) ABSTRACT

Node recovery in a communication network, includes determining whether a heartbeat message is received by a first node from a second node upstream of the first node within a heartbeat timeout threshold of the first node in response to an occurrence of a fault condition at the first node. In response to determining that the heartbeat message is not received within the heartbeat timeout threshold, a probe message may be communicated to one or more third nodes downstream of both the first node and the second node, wherein receipt of the probe message by one of the third nodes is operable to prevent deletion of previously-committed resources at the third node and associated with the second node.

### TECHNICAL FIELD

This invention relates generally to the field of communication networks and more specifically to state recovery for a node in a communication network.

### BACKGROUND

A communication network includes paths of nodes that route packets through the network. From time to time, multiple nodes along a path may experience faults, and lose information associated with its path membership and allocated resources. Known techniques for recovering such path membership and allocated resource information rely on an exchange of messages between a recovering node and a neighboring node in the network. Such techniques, however, may be ineffective and lead to decreased network performance where two or more nodes in a path experience a fault, as such recovery messages may not be properly exchanged.

### SUMMARY OF THE DISCLOSURE

In accordance with the present invention, disadvantages and problems associated with previous techniques for node state recovery may be reduced or eliminated.

According to one embodiment of the present invention, a method for node recovery in a communication network comprises determining whether a heartbeat message is received by a first node from a second node upstream of the first node within a heartbeat timeout threshold of the first node in response to an occurrence of a fault condition at the first node. In response to determining that the heartbeat message is not received within the heartbeat timeout threshold, a probe message may be communicated to one or more third nodes downstream of both the first node and the second node, wherein receipt of the probe message by one of the third nodes is operable to prevent deletion of previously-committed resources at the third node and associated with the second node.

Certain embodiments of the invention may provide one or more technical advantages. A technical advantage of one embodiment may be that reserved resources in a network may not be undesirably torn down or deleted when two or more nodes recover from faults. Under the methods and systems disclosed herein, a recovering node which is unable to receive a heartbeat message from a node upstream of it may communicate probe messages downstream, which in turn prevent the downstream nodes from exceeding their respective recovery timeout thresholds and deleting reserved resources in response to exceeding such thresholds. Such an approach may reduce the occurrence of degraded network performance associated with traditional approaches to node recovery.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating a network system according to one embodiment of the present disclosure;

FIG. 2 is a flowchart illustrating one embodiment of a method of communicating a probe message that may be used with network system of FIG. 1; and

FIG. 3 is a flowchart illustrating one embodiment of a method of processing a probe message that may be used with network system of FIG. 1.

### DETAILED DESCRIPTION OF THE DRAWINGS

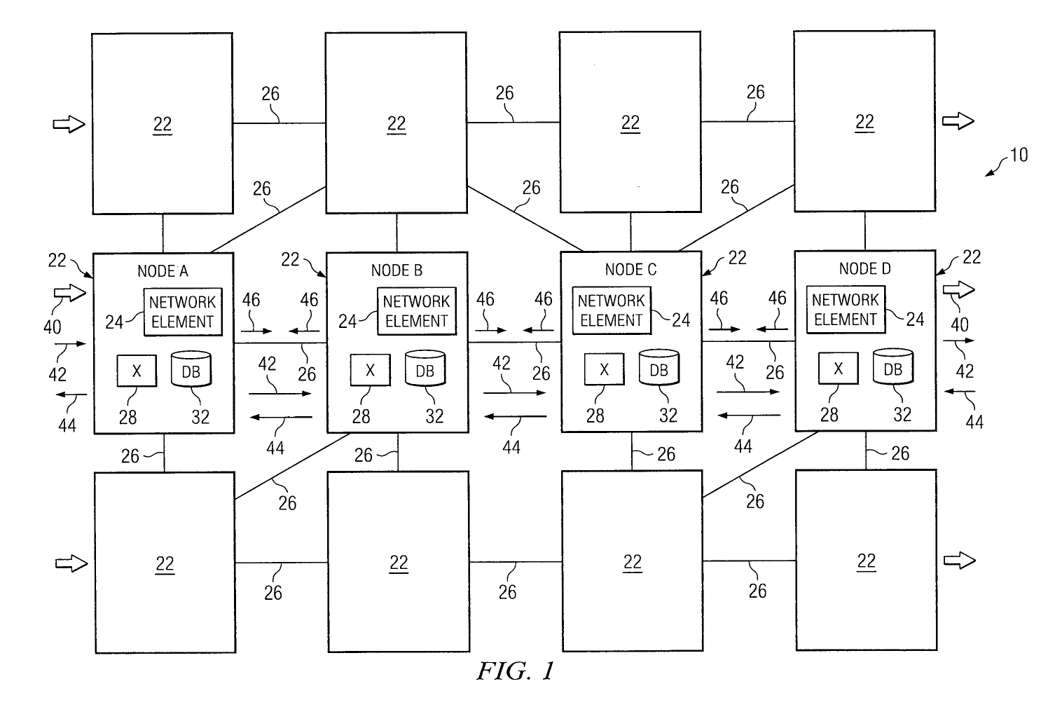

Embodiments of the present invention and its advantages are best understood by referring to FIGS. 1 through 3 of the drawings, like numerals being used for like and corresponding parts of the various drawings.

FIG. 1 is a block diagram illustrating a network system 10 according to one embodiment of the present disclosure.

System 10 includes components such as network nodes. In general, a network node may include any suitable arrangement of components operable to perform the operations of the network node. As an example, a network node may include logic, an interface, memory, other component, or any suitable combination of the preceding. “Logic” may refer to hardware, software, other logic, or any suitable combination of the preceding. Certain logic may manage the operation of a device, and may comprise, for example, a processor. “Processor” may refer to any suitable device operable to execute instructions and manipulate data to perform operations.

“Interface” may refer to logic of a network node operable to receive input for the network node, send output from the network node, perform suitable processing of the input or output or both, or any combination of the preceding, and may comprise one or more ports, conversion software, or both.

“Memory” may refer to logic operable to store and facilitate retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Network system 10 communicates information through signals. A signal may refer to an optical signal transmitted as light pulses. As an example, an optical signal may have a frequency of approximately 1550 nanometers and a data rate of 10, 20, 40, or over 40 gigabits per second. A signal may alternatively refer to an electrical signal.

A signal may communicate information in packets. A packet may comprise a bundle of data organized in a specific way for transmission, and a frame may comprise the payload of one or more packets organized in a specific way for transmission. A packet may carry any suitable information such as voice, data, audio, video, multimedia, control, signaling, other information, or any combination of the preceding. The packets may comprise any suitable packets, such as Internet Protocol (IP) packets or time division multiplexed (TDM) packets.

According to the illustrated embodiment, network system 10 may include one or more networks. A network may include nodes 22 coupled by fibers 26 in a mesh topology as shown in FIG. 1 or any other suitable topology.

According to one embodiment, a network may utilize standards such as the Multi-Protocol Label Switching (MPLS) standard. MPLS may refer to a highly-scalable, protocol-agnostic, data-carrying mechanism. In an MPLS network, data packets may be assigned labels such that packet-forwarding decisions are made based on the contents of the label, without the need to examine other contents of the packet. Thus, MPLS may allow creation of end-to-end circuits using any transmission protocol across any type of transport medium, such as Ethernet, Synchronous Optical Network (SONET), or wavelength division multiplexing (WDM) (such as dense wavelength division multiplexing (DWDM)) techniques, for example.

A node 22 routes a packet to a next node 22 of a path according to the destination address of the packet (e.g., a destination address set forth in the label of an MPLS-labeled packet). Typically, the destination address specifies a node identifier, such as an Internet Protocol (IP) address, that uniquely identifies a destination node 22. A node 22 may have a table that specifies an output port for a given destination address.

According to an embodiment, a path, or circuit, may refer to a sequence of nodes 22 comprising endpoint nodes 22 and zero or more intermediate nodes 22 between the endpoint nodes 22. Endpoint nodes 22 may include an ingress node 22 and an egress node 22. An ingress node 22 may refer to a node 22 at which a path message initiates, and an egress node 22 may refer to a node 22 at which a path message terminates. Accordingly, a path message may travel from an ingress node 22, through the zero or more intermediate nodes 22, to an egress node 22.

An endpoint node 22 may be identified in any suitable manner. According to one embodiment, a node 22 may be identified as an endpoint node 22 if the node 22 is a network facility, if the node 22 comprises a WDM interface that has no neighbor node 22, or if the node 22 does not have a provisioned cross connect 28.

Network system 10 may also utilize Resource Reservation Protocol (RSVP) or another protocol configured to reserve resources (e.g., bandwidth) within network system 10. RSVP and other similar protocols may be used to request or deliver specific levels of quality of service (QoS) for data streams. For example, in the embodiment shown in FIG. 1, RSVP may define how resource reservations may be placed in network system 10 and how such resource reservations may be relinquished once the need for them has ended. For example, use of RSVP may result in resources being reserved in each node 22 along a path.

Path messages may travel hop by hop from an ingress node to an egress node. According to the illustrated example, path messages flow from node A through nodes B and C to node D. When describing relationships among nodes 22 in network system 10, the term “downstream” may be used to refer to a node 22 that is in the direction of path message flow relative to another node 22, while the term “upstream” may be used to refer to a node 22 that is opposite of the direction of path message flow relative to another node 22 (e.g., node B is upstream of node C and downstream of node A).

Path information may refer to information describing one or more paths. As an example, path information may include the sequence of nodes 22 included in a path. According to one embodiment, path information may also include monitoring information. Monitoring information may refer to information that may be used to monitor network system 10. Monitoring information may include, for example, information describing the performance and condition of network system 10. In the same or alternative embodiments, path information may also include a unique path identifier for each of one or more paths. In MPLS-based networks, path information may be set forth in the MPLS labels assigned to individual packets, and thus packets may be routed in accordance with information set forth in such labels.

A node 22 may include any suitable devices. According to the illustrated embodiment, a node 22 includes a network element 24, a cross connect 28, and a database 32. A network element 24 may include any suitable device operable to route packets to or from network 20. Examples of network elements 24 include dense wavelength division multiplexers (DWDMs), access gateways, endpoints, softswitch servers, trunk gateways, access service providers, Internet service providers, or other device operable to route packets to or from network 20. In some embodiments, network element 24 may also include a device operable to store certain information, for example unique path identifiers for one or more paths comprising the node 22 associated with the network element 24 and/or variables indicative of the node resources (e.g., bandwidth and/or quality of service) allocated to such paths. In these embodiments, such information may be stored on a persistent storage medium.

A cross connect 28 may comprise a coupling device that couples hardware coupled to the input and output ports of the cross connect 28. According to one embodiment, fiber patch cords may be used to make the circuit connections. Cross connect 28 may be incorporated with or separate from network element 24. A cross connect 28 may map a specific input port to a specific output port such that a packet received at the input port is routed to the output port. According to one embodiment, this mapping may be used to discover the paths of network system 10.

A database 32 may comprise a device operable to store path information and/or link state information, for example, a link state database (LSDB). Link state information describes the links and paths of network system 10.

Network system 10 may include any suitable number of fibers 36. Fibers 36 may refer to any suitable fiber operable to transmit a signal between two or more nodes 22. According to one embodiment, a fiber 36 may represent an optical fiber. An optical fiber typically comprises a cable made of silica glass or plastic. The cable may have an outer cladding material around an inner core. The inner core may have a slightly higher index of refraction than the outer cladding material. The refractive characteristics of the fiber operate to retain a light signal inside of the fiber. In the same or alternative embodiments, one or more nodes 22 may be coupled via any other suitable transmission medium (e.g., electrically-conductive wire and/or wireless transmissions).

According to one embodiment of operation, creation of one or more paths in network system 10 may involve gathering path information describing the paths of network system 10, and distributing the path information through network system 10. Path information may be gathered by sending path message 42 from an ingress node 22, through zero or more intermediate nodes 22, to an egress node 22.

Path message 42 may travel in any suitable direction through nodes 22, for example, in the direction of the flow of traffic 40 or opposite to the direction of the flow of traffic 40. Path message 42 may gather path information as it passes through nodes 22 from an ingress node 22 to an egress node 22. The path information may be gathered according to any suitable method. Egress node 22 may collect the gathered path information, and send the path information back to ingress node 22 in a return message 44. The path information may be stored at databases 32 of ingress node 22.

In one example, path message 42 and return message 44 may perform other operations in addition to gathering path information. In the example, path message 42 and return message 44 may be used to reserve resources, for example, bandwidth (e.g., using RSVP as discussed above). For example, path message 42 may comprise an RSVP path message, and return message 44 may comprise an RSVP reservation-request message.

In the example, path message 42 may describe requested resources, for example, bandwidth requirements, quality of service requirements, and/or parameters of data to be sent. The path messages 42 may be propagated from an ingress node 22 through intermediate nodes 22 to egress nodes 22. Each egress node 22 interested in the data may confirm the flow by sending a reservation-request message through the network. The reservation-request message describes the bandwidth characteristics of the data to be received from the ingress node 22. As the reservation-request messages propagate back towards the ingress node 22, intermediate nodes 22 determine whether or not to accept the proposed reservation and commit resources (e.g., bandwidth and/or quality of service) based on their capacity. If an intermediate node 22 decides to accept the proposed reservation, the resources are committed and the reservation-request message is propagated to a next node 22 in the path. When resources are committed at a particular node 22, parameters regarding the committed resources (e.g., bandwidth, quality of service, unique path identifiers) may be stored in the database 32 and/or network element 24 associated with the particular node 22.

The path information stored at databases 32 may be distributed to other nodes 22. According to one embodiment, path information may be distributed using a routing protocol, such as the Open Shortest Path First (OSPF) routing protocol distribution. As an example, a distribution message may comprise an OSPF message.

In certain embodiments, path messages 42 similar to those previously communicated in network system 10 are periodically communicated downstream through a particular path in order to “refresh” path information, link state information, and/or committed resources at each node 22. In such embodiments, nodes 22 may delete or “tear down” previously-stored path information, link state information, and/or committed resource parameters unless such information is regularly refreshed within a refresh timeout threshold.

In node recovery scenarios, a recovering node may start a recovery timer associated with its recovery timeout threshold when heartbeat messages have been successfully exchanged with the associated upstream node. Upon the expiration of the timer, the node may delete or “tear down” previously-stored path information, link state information, and/or committed resource parameters that are not refreshed or recovered with the upstream node before the recovery timeout.

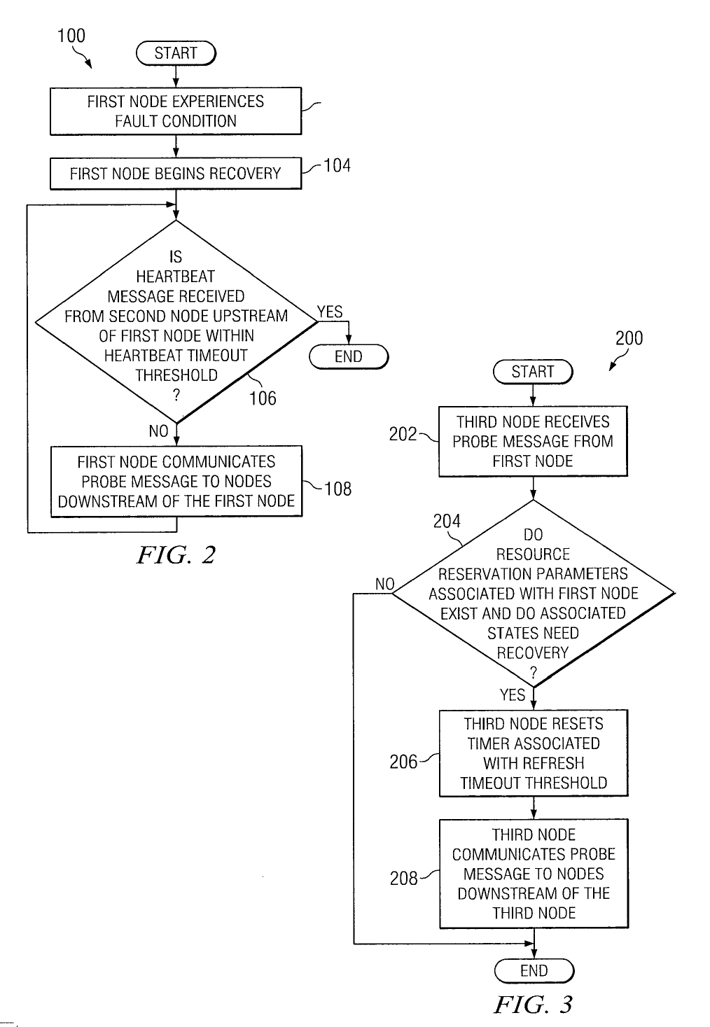

In the same or alternative embodiments, path messages 42 may also be used as “probe” messages. As described in greater detail below, in response to not receiving a heartbeat message from an upstream node, a node may communicate a probe message to downstream nodes that are further downstream of the upstream node in a previously-established path. Receipt of a probe message by a downstream node may in turn cause a node 22 to extend its recovery timeout threshold and/or reset a timer associated with the recovery timeout threshold, such that nodes receiving the probe message do not delete or tear down previously-stored path information, link state information, and/or committed resource parameters due to failure to receive the associated recovery information. Uses for probe messages are further explained in connection with FIGS. 2 and 3 below.

According to certain embodiments of the present disclosure, each node 22 may communicate a heartbeat or “hello” message 46 to its neighboring nodes. Heartbeat messages 46 may be communicated at periodic intervals, and the receipt or non-receipt by a node 22 of heartbeat messages 46 may indicate an operational status of each of its neighboring nodes 22. For example, receipt of a heartbeat message 46 may indicate to a receiving node 22 that its neighboring node 22 is functioning correctly and/or properly coupled to the receiving node 22. As another example, non-receipt of a heartbeat message 46 may indicate to a non-receiving node 22 that its neighboring node 22 is in a fault state (e.g., power failure, restart, and/or other failure) and/or is not properly coupled to the neighboring node 22.

Modifications, additions, or omissions may be made to network system 10 without departing from the scope of the invention. The components of network system 10 may be integrated or separated according to particular needs. Moreover, the operations of network system 10 may be performed by more, fewer, or other devices. Additionally, operations of network system 10 may be performed using any suitable logic. As used in this document, “each” refers to each member of a set or each member of a subset of a set.

When a particular node 22 experiences a fault condition or failure, path information and/or link state information (including, if applicable, parameters regarding committed resources) may be lost by database 32 and/or another component of the node 22. In traditional network systems, a recovering node 22 may rely on a neighboring upstream node 22 to recover path information and/or link state information. As discussed above, a node 22 experiencing a fault may cease communicating its heartbeat message 46. In response to failing to detect a heartbeat message 46 from the faulting node 22 for a certain fault detection timeout threshold, a node 22 upstream of faulting node 22 may determine that the faulting node 22 may need recovery assistance. Accordingly, when the upstream node 22 again receives a heartbeat message 46 indicating that the faulting/recovering node 22 is no longer experiencing a fault, upstream node 22 may communicate recovery information to the recovering node 22. In certain embodiments, this information may be communicated in the form of a path message 42 with a flag or variable set indicating that the path message 42 includes recovery information for the recovering node 22. Using this recovery information (which may include, without limitation, path information, link state information, and/or parameters regarding committed resources) recovering node 22 may be able to recover its pre-fault state without deleting or tearing down pre-existing link states and/or resource commitments associated with its network element 24.

However, recovery based on this traditional scheme may fail when two or more nodes 22 in a path experience a substantially contemporaneous fault as an upstream faulting/recovering node 22 may fail to communicate recovery information to a downstream faulting/recovering node 22 in such a scenario. As an illustration, if node B and node C depicted in FIG. 1 were to experience substantially contemporaneous faults, upstream faulting/recovering node B may fail to communicate recovery information to faulting/recovering node C within a recovery window for faulting/recovering node C. Even though node B and C have successfully exchanged heartbeat messages, which causes node C to start its associated recovery timer, upstream faulting/recovering node B may fail to communicate this recovery information for any number of reasons. For example node B may fail to communicate recovery information due to fully recovering at a time significantly later than the full recovery of node C. As another example, node B may fail to communicate recovery information due to a communication failure with its upstream node A (e.g., a communication failure between node A and node B). Accordingly, if the faulting/recovering node C fails to receive recovery information from node B within node C's recovery time threshold, it may tear down pre-fault committed resources, thus potentially inducing undesirable communication delay in network system 10.

FIG. 2 is a flowchart illustrating one embodiment of a method 100 of communicating a probe message that may be used with network system 10 of FIG. 1 to overcome the disadvantages of traditional node state recovery techniques.

Method 100 may begin at step 102, where a first node of a network system (e.g., node B of network system 10) may experience a fault condition. After the fault condition is resolved, the method may proceed to step 104, where the faulting/recovering first node may begin recovery.

During recovery, at step 106, the recovering first node may determine whether a heartbeat message (e.g., heartbeat message 46) is received from a second node upstream (e.g., node A) of the recovering first node within a heartbeat timeout threshold. If a heartbeat message is received within the heartbeat timeout threshold (e.g., indicating normal operation between the first node and the second node), method 100 may end. Otherwise if a heartbeat message is not received within the heartbeat timeout threshold (e.g., due to the second node recovering, being in a fault state, and/or connectivity problems between the first node and the second node), method 100 may proceed to step 108.

At step 108, in response to a determination that a heartbeat message has not been received, the first node may communicate a probe message to nodes downstream of the first node. In certain embodiments, the probe message may comprise a path message with a flag or variable set indicating its status as a probe message. The first node may determine the appropriate downstream nodes to which to communicate the probe message in any suitable manner, including without limitation analyzing communication parameters stored in a network element of the recovering node (e.g., determining if the first node has any cross connects coupling the second node to any downstream nodes). After completion of step 108, method 100 may return to step 106 to again determine whether a heartbeat message has been received from the upstream node.

FIG. 3 is a flowchart illustrating one embodiment of a method 200 of processing a probe message that may be used with network system 10 of FIG. 1 to overcome the disadvantages of traditional node state recovery techniques.

Method 200 may begin at step 202, where a third node (e.g., node B) of network system (e.g., node C of network system 10) may receive a probe message from an upstream node such as the recovering node discussed in association with FIG. 2. At step 204, in response to receipt of the probe message, the third node may determine whether resource reservation parameters associated with the first node exist on the third node (e.g, whether communication parameters stored in a network element and/or database of the third node are associated with the first node). Determining whether such parameters exist may include determining if the third node has any cross connects coupling the first node to any nodes downstream of the third node. If such resource reservation parameters do exist, method 200 may further check whether the associated resource reservation states need recovery. If such states do need recovery, method 200 may proceed to step 206. Otherwise, if such resource reservation parameters do not exist or the resource reservation parameters exist but the associated resource reservation states do not need recovery, method 200 may end.

At step 206, in response to a determination that resource reservation parameters/states associated with the first node need recovery, the third node may reset a timer associated with its refresh timeout threshold, thus preventing the third node from deleting and/or tearing down previously-committed resources associated with the first node. In the same or alternative embodiments, the third node may increase the recovery timeout threshold, which may also prevent the third node from deleting and/or tearing down previously-committed resources associated with the first node.

At step 208, the third node may communicate the probe message to nodes (e.g., node D) downstream of the third node. In certain embodiments, the probe message may comprise a path message with a flag or variable set indicating its status as a probe message. The third node may determine the appropriate downstream nodes to which to communicate the probe message in any suitable manner, including without limitation analyzing communication parameters stored in a network element of the third node (e.g., determining which cross connects couple the first node to any nodes downstream of the third node). After completion of step 208, method 200 may end.

Nodes receiving a probe message from the third node as set forth in Step 208 may also process the probe message in a manner similar or identical to that set forth in method 200.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that reserved resources in a network may not be undesirably torn down or deleted when two or more nodes recover from faults. Under the methods and systems disclosed herein, a recovering node which is unable to receive a heartbeat message from a node upstream of it may communicate probe messages downstream, which in turn prevent the downstream nodes from exceeding their respective recovery timeout thresholds and deleting reserved resources in response to exceeding such thresholds. Such an approach may reduce the occurrence of degraded network performance associated with traditional approaches to node recovery.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for node recovery in a communication network, comprising:
in response to an occurrence of a fault condition at a first node, determining whether a heartbeat message is received by the first node from a second node upstream of the first node within a heartbeat timeout threshold of the first node; and
in response to determining that the heartbeat message is not received within the heartbeat timeout threshold, communicating a probe message to one or more third nodes downstream of both the first node and the second node, wherein receipt of the probe message by one of the third nodes is operable to prevent deletion of previously-committed resources at the third node associated with the second node.

2. The method of claim 1, wherein the previously-committed resources are reserved in accordance with a Resource Reservation Protocol (RSVP) path message.

3. The method of claim 1, wherein the probe message is operable to prevent deletion of the previously-committed resources by resetting a timer associated with a recovery timeout threshold of the one or more third nodes.

4. The method of claim 1, wherein the probe message is operable to prevent deletion of the previously-committed resources by increasing a recovery timeout threshold of the one or more third nodes.

5. The method of claim 1, wherein the probe message comprises a path message.

6. A method for node recovery in a communication network, comprising:
receiving a probe message at a first node downstream of a second node, the probe message indicative of a fault condition occurring at least one of the second node and a node upstream of the second node;
determining whether previously-committed resources associated with the second node exist at the first node and the associated resource reservation states need recovery; and
in response to determining that previously-committed resources associated with the second node exist at the first node and the associated resource reservation states need recovery, preventing deletion of the previously-committed resources at the first node.

7. The method of claim 6, further comprising, in response to determining that previously-committed resources associated with the second node exist at the first node and the associated resource reservation states need recovery, communicating the probe message to one or more third nodes downstream of both the first node and the second node, wherein receipt of the probe message by one of the third nodes is operable to prevent deletion of previously-committed resources at such third node and associated with the second node.

8. The method of claim 7, wherein preventing deletion of the previously-committed resources at such third node includes resetting a timer associated with a recovery timeout threshold of such third node.

9. The method of claim 7, wherein preventing deletion of the previously-committed resources at such third node includes increasing a recovery timeout threshold of such third node.

10. The method of claim 6, wherein the previously-committed resources at the first node are reserved in accordance with a Resource Reservation Protocol (RSVP) path message.

11. The method of claim 6, wherein preventing deletion of the previously-committed resources at the first node includes resetting a timer associated with a recovery timeout threshold of the first node.

12. The method of claim 6, wherein preventing deletion of the previously-committed resources at the first node includes increasing a recovery timeout threshold of the first node.

13. The method of claim 1, wherein the probe message comprises a path message.

14. A communication network, comprising:
a plurality of nodes comprising at least a first node, a second node upstream of the first node, and a third node downstream of the first node and the second node;
the first node operable to:
in response to an occurrence of a fault condition at a first node, determine whether a heartbeat message is received by the first node from the second node within a heartbeat timeout threshold of the first node; and
in response to determining that the heartbeat message is not received within the heartbeat timeout threshold, communicate a probe message to the third node; and
the third node operable to:
receive the probe message;
determine whether previously-committed resources associated with the second node exist at the third node and the associated resource reservation states need recovery; and
in response to determining that previously-committed resources associated with the second node exist at the third node and the associated resource reservation states need recovery, prevent deletion of the previously-committed resources.

15. The communication network of claim 14, wherein the previously-committed resources are reserved in accordance with a Resource Reservation Protocol (RSVP) path message.

16. The communication network of claim 14, wherein the third node is operable to prevent deletion of the previously-committed resources by resetting a timer associated with a recovery timeout threshold of the third node.

17. The communication network of claim 14, wherein the third node is operable to prevent deletion of the previously-committed resources by increasing a recovery timeout threshold of the third node.

18. The communication network of claim 14, wherein the probe message comprises a path message.

19. The communication network of claim 14, the third node further operable to, in response to determining that previously-committed resources associated with the second node exist at the third node, communicate the probe message to one or more fourth nodes downstream of the first node, the second node, and the third node, wherein receipt of the probe message by one of the fourth nodes is operable to prevent deletion of previously-committed resources at such fourth node and associated with the third node.
